(19) United States
(12) Patent Application Publication
(10) Pub. No.: US 2003/0159556 A1
(43) Pub. Date: Aug. 28, 2003

(54) Method and apparatus for measuring and cutting piping

(76) Inventors: Susan Kay Cleveland, West Concord, MN (US); Lee Dale Cleveland, West Concord, MN (US)

Correspondence Address: The Law Office of Debra J. Fickler, 12525 Grandview Drive, Huntley, IL, 60142-9501, US

(21) Appl. No.: 10/087,403

(22) Filed: Feb. 28, 2002

(51) Int. Cl. B26D 1/00

(52) U.S. Cl. 83/13

(57) ABSTRACT

A method and tool is provided for measuring and cutting the seam allowance of a piping material from the salvage portion. The piping material is composed of a cording material encased in a fabric such as cloth, leather, vinyl, flexible plastic or paper. Piping is typically used as a decorative embellishment on clothing, blankets, quilts, or may act to hide a seam or give strength to the article such as used in upholstery, slip and seat covers, and luggage. The piping trimming tool is used to cut the salvage to a predetermined seam allowance in preparation for sewing and incorporating the piping into the article.

### FIELD OF THE INVENTION

This invention relates to a method for measuring and cutting piping. The piping is typically composed of a cord material that is encased in fabric with a salvage of material adjacent to the encased cord material. More specifically, the method and apparatus may be used to measure a predetermined width of salvage material and subsequently used to facilitate the cutting of any excess salvage material beyond the predetermined width.

### BACKGROUND OF THE INVENTION

Piping is typically made using a stiff, but flexible cording material made of woven or twisted strand of thread or yarn. However, some cording may be composed of plastic or metal tubing. The cording material is encased in fabric that may be a cloth fabric, vinyl, leather or similar flexible materials. The cording material is typically placed on the wrong-side or inside of the fabric. The ends of the fabric are then folded together and the cording material is pushed to the edge of the fold such that the cording material is sandwiched between the folded fabric. The cording is held in position by stitching the fabric with thread along the cording material such that the cording material is tightly encased in the fabric by the fabric fold and the sewn stitches. The excess material adjacent to the encased cording material is commonly called the “salvage.” The width of the salvage may vary depending upon the starting width of the fabric used. The salvage is typically trimmed to a specific width for incorporating it a garment, quilt, slipcover, upholstery or other item

Piping is typically used as an accent in the seams or to strength the seam of sewn items such as clothing furniture upholstery, automobile seats and seat covers, bags, luggage, draperies, slipcovers, blankets and quilts. One common example is the leather seats utilized in mini-vans. The piping sewn in the seams of the leather function to camouflage the stitches of the seam that are often visible when the leather is stretched and to provide stiffness along the seam to prevent sagging of the leather.

Adding piping during the construction of an article is often difficult due to the added thickness of material created by the fabric casing. In most sewing applications, a seam is created by placing the wrong-sides of two pieces of fabric together with the edges of the fabric pieces aligned. A long chain of stitches is theft sewn a predetermined distance from the aligned edge by using a guideline on the base plate of a sewing machine. This distance is called the seam allowance. Once the two layers of fabric are stitched, the material is opened to reveal the right sides of the two pieces of fabric that are now one piece. To add piping to a seam the piping must be contrasted before placing between the two pieces of fabric as described above.

The piping is constructed by placing a cording material inside the fold of the casing fabric such that is touches the wrong sides of the fabric. To hold the cording material in place, a chain of stitches is sewn as close as possible to the edge of the cording material on the right side of the fabric. Once the desired length of piping is constructed, the salvage, the edges of the fabric opposite the encased cording, must be trimmed the desired width which will be the seam allowance of the two pieces of fabric to be sewn together. The salvage must be trimmed to the proper seam allowance. Once trimmed, the pinning is placed between the two pieces of fabric to be sewn such that the piping is sandwiched between the right-sides of the two pieces of fabric and the cording material in away from the edges to be sewn. The three layers of materials are then sewing at the distance equaling the seam allowance from edges. Once sewn, the two pieces of material are then opened to reveal one piece of sewn fabric with the piping appearing at the seam.

If the salvage of the piping is not trimmed to the proper seam allowance, the finished product may show the chain of stitches that were sewn to hold the cording material in place or may show both the stitches and excess piping salvage material. This may result in an uneven and puckered seam and is visibility distracting. Moreover, if there is excess salvage on the piping piece, the salvage will extend beyond the seam allowance of the two pieces of fabric. When the pieces are sewn, the excess piping salvage covers the seam allowance guide mark on the sewing machine and thereby, making impeding the use of the seam allowance guide on the sewing machine and may result in an uneven seam.

The salvage of the pining is typically trimmed after the chain of stitches are sewn that hold the cording material in the fabric casing. A ruler is used to measure the proper seam allowance length from the chain of stitches and often a piece of chalk or grease pencil is used to mark the proper distance. Once the seam allowance is marked, the seamstress then cuts the salvage along the marked line. This is a lengthy process, especially when sewing large items such as large quilts and upholstery or covers for chairs and couches. Furthermore, the method is difficult when the material is slippery because when pressure is applied to the ruler, the slippery fabric has a tendency to move under pressure. Some seamstress use a short cut by measuring the proper seam allowance on the piping salvage and making a small length cut and repeating the process over and over until the piping salvage is trimmed. Obviously, this is a lengthy and often inaccurate method for creating an even seam allowance. Likewise, if the seamstress misreads the markings on the ruler, the seam allowance may not be even. Therefore, a method for measuring the piping seam allowance is desired. A method for trimming the piping salvage is also desired. Likewise, a tool that assists in measuring the proper seam allowance and also assists with the trimming of the piping salvage is also desired. The tool must be easy to use and provides a quick procedure quickly measuring and cutting the piping salvage.

### BRIEF SUMMARY OF THE INVENTION

In accordance with the present invention a method for measuring and trimming piping salvage to the proper seam allowance is provided. The method provides for quickly measuring a predetermined seam allowance width including a method for accurately trimming the seam allowance. A tool is also provided that allows for the measuring of multiple, predetermined seam allowance widths. The disclosed tool assists with the hold of the piping while measuring and is used as a cutting guide for quick trimming of the seam allowance. The tool allows the seamstress to view piping and the salvage to ensure the proper seam allowance is achieved. By applying pressure to the tool, piping made with slippery casing fabrics can be firm held and trimmed without movement of the tool or slipping of the fabric.

### BRIEF DESCRIPTION OF THE DRAWINGS

FIG. 1 is a top perspective view of a piping trimming tool showing multiple piping channels and a cutting guide surface;

FIG. 2 is a side plan view illustrating the multiple piping channels;

FIG. 3 is a bottom perspective view of the piping trimming tool showing multiple piping channels;

FIG. 4A is illustrates a coding material placed on a fabric;

FIG. 4B is an illustration of the cording material encased in a fabric to create piping;

FIG. 4C is a side plan view of the piping trimming tool with the cording material and fabric contained in a piping channel and a piping salvage extending beyond the piping trimming tool; and

FIG. 5 is a plan top view of the piping tool with the cording material and encased in fabric in the piping channel with the piping salvage extending beyond the piping trimming tool and a cutting blade being guided by the cutting guide surface.

### DETAILED DESCRIPTION OF THE INVENTION

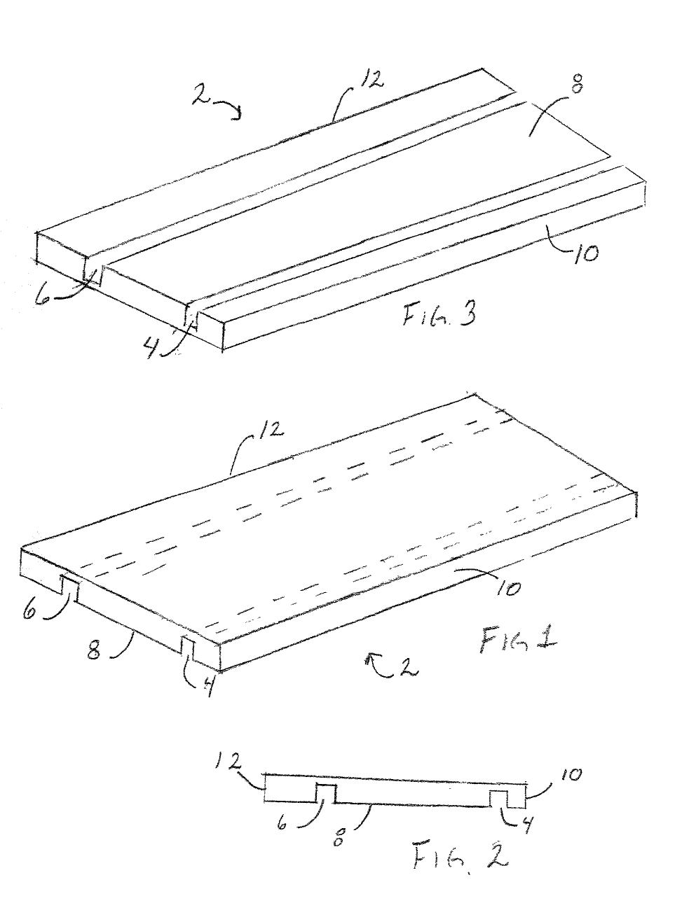

The invention may be embodied in various forms to accommodate various widths of cording materials and seam allowances. Turning to FIGS. 1-3, a piping trimming tool 2 is shown that is composed of a transparent acrylic, Plexiglas or similar transparent material. One embodiment of the invention utilized a 0.1 inch thick acrylic substrate having a width of 3 inches by 12 inches long. However, other widths and thicknesses of acrylic, Plexiglas or similar material may be used.

Piping trimming tool 2 in FIGS. 1-3 has two cording channels, 4 and 6 cut from the bottom of the acrylic (see FIG. 3). One embodiment of the invention utilized cording channels 4 and 6 having a width of 0.125 inches and a depth of 0.075 inches as measured from the bottom surface 8. The long length of piping trimming tool 2 form cutting guide surface 10 and 12 Cutting guide surfaces 10 and 12 are perpendicular to bottom surface 8. Cording channel 4 is parallel to cutting guide surface 10 and is a distance of 0.25 inch from cutting guide 10. Likewise, piping channel 6 is parallel to cutting guide surface 12 and a distance of 0.5 inches from cutting guide surface 12

The embodiment of piping trimming tool 2 shown in FIGS. 1-3 is a tool that would be used for quilting. In quilting applications, piping is used as a decorative embellishment. The cording material used is typically of a smaller diameter because bulkier piping may be uncomfortable when the quilt is used as a blanket. Thus, cording channels 4 and 6 as shown can accommodate smaller cording materials up to 0.008 inch or 2 mm in diameter. However, piping trimming tool 2 is not limited to 0.008 inch diameter cording materials.

Turning to FIG. 4A, piping is constructed using a cording material 14 that is placed on the wrong-side of fabric 16. Fabric 16 is cut into a long, narrow strip such that the width of fabric 16 should be greater than two times the finished piping seam allowance plus the diameter of the cording material 14. With cording material 14 placed in the middle of the wrong-side of fabric 16, one end is folded over cording material 14. Cording material 14 is then pushed into the fold 18 as shown in FIG. 4B such that the right-side of fabric 16 is exposed. A chain of stitches 20 is then sewn close to cording material 14 to create piping 22 with salvage 24.

Before piping 22 can be incorporated into a quilt or other article, salvage 24 of piping 22 must be trimmed to the proper seam allowance. Piping trimming tool 2 is used to trim salvage 24 by placing the portion of piping 22 with cording material 14 in cording channel 6 as shown in FIG. 4C. Piping trimming tool 2 is transparent to allow the user to see piping 22 and ensure that the cording material 14 is properly located in cording channel 6. Cording channel 6 is 0.5 inch from cutting guide surface 12 which will be used to create seam allowance 26 having a width of 0.5 inch.

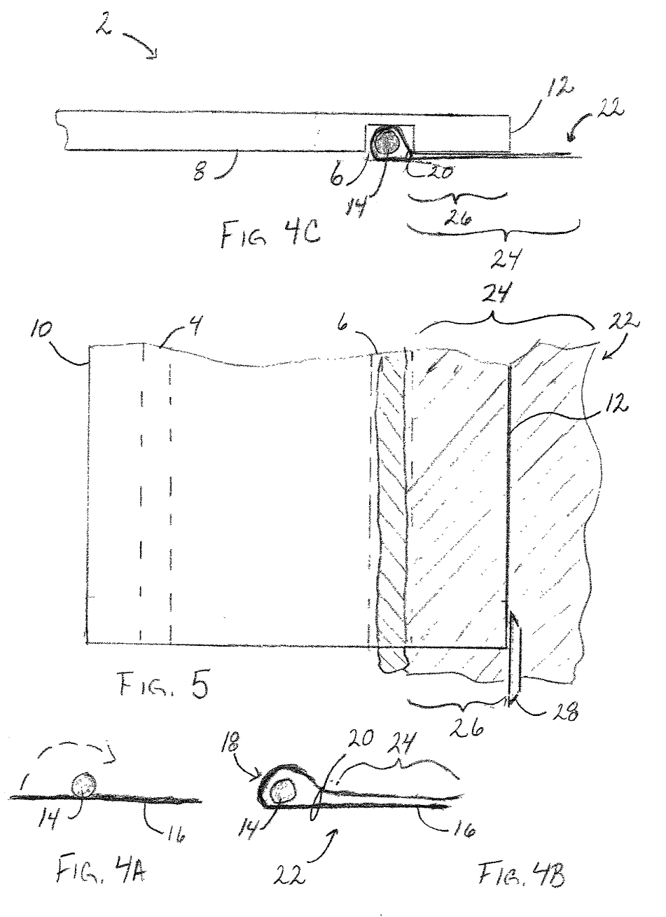

To trim salvage 24 to seam allowance 26, pressure is applied by hand to the top of piping trimming tool 2 such bottom surface 8 firmly holds piping 22. A rotary trimmer such as one manufactured by Fiskar™ or Exacto™ is used to trim salvage 24. Rotary trimming blade 28 is placed along cutting guide surface 12 as shown in FIG. 5. As rotary trimming blade 28 is ran along cutting guide surface 12, salvage 24 is trimmed to seam allowance 26. To continue cutting past the length of piping trimming tool 2, trimmed piping 22 is pulled through cording channel 6 until the untrimmed piping 22 is along cutting guide surface 12. This is repeated until the desired length of piping 22 is trimmed. Note that FIG. 5 illustrated piping trimming tool 2 being used by a right-handed seamstress. Piping trimming tool 2 can be rotated 180° for a left-handed user.

For seam allowance 26 having a width of 0.25 inch, piping 22 can be trimmed by placing the cording material 14 portion of piping 22 in cording channel 4. Rotary trimming blade 28 is then placed next to cutting guide surface 10 to trim salvage 24 to a 0.25 inch seam allowance 26.

In an alterative embodiment, piping trimming tool 2 may have multiple cording channels that are parallel with cutting guide surfaces 10 and 12. This allows for additional seam allowance 26 widths to be cut using one piping trimming tool 2. Likewise, cording channels 4 and 6 may be of greater widths to accommodate larger diameter cording material 14. In a third embodiment, piping trimming tool 2 may have multiple cording channel having more than one width and placed at different distances from cutting surfaces 10 and 12. For example, piping trimming tool 2 may have cording channel 4 having a width of 0.125 inch at a distance of 0.25 inch from cutting surface 4 as shown in FIGS. 1-3. Additionally, a second, parallel cording channel (not shown) having a width of 0.125 inch and 0.5 inch from cutting guide surface 10. Likewise cording channel 6 may be 0.25 inch wide at 0.5 inch from cutting guide surface 12 and a forth cording channel (not shown) of 0.25 wide at 1 inch from cutting guide surface 12

A forth embodiment of piping trimming tool 2 (not shown) utilized a thin layer (0.22 mm) of rubber having a width of 0.25 inch placed between the cording channels and the cutting guide surfaces, and parallel down the middle of piping tool 2 on bottom surface 8. The rubber strips assist in holding the piping 22. This is extremely helpful when cutting slippery fabrics such as fabrics with metallic threads, leathers and vinyl.

While the invention has been described with respect to specific examples including presently preferred modes of carrying out the invention, those skilled in the art will appreciate that there are numerous variations and permutations of the above described systems and techniques that fall within the spirit and scope of the invention as set forth in the appended claims.

We claim:

1. A method for trimming a salvage of a piping material, the method comprising:
covering a piping material with a piping trimming tool;
positioning a first portion of the piping material in a holding device;
cutting the piping material next to a cutting guide surface; and
removing a salvage material.

2. The method of claim 1 wherein the step of positioning a portion of piping material in a holding device includes placing a section of piping material containing a fabric and a cording material in a holding device.

3. The method of claim 2 wherein the step of placing a section of piping material containing a fabric and a cording material in a holding device further includes placing the fabric and cording material in a rectangular channel.

4. The method of claim 1 wherein the step of covering a piping material with a piping trimming tool includes covering a predetermined seam allowance portion with the piping trimming tool.

5. The method of claim 1 wherein the step of cutting the piping material next to a cutting guide surface includes placing pressure on the piping trimming tool.

6. The method of claim 1 wherein the step of cutting the piping material next to a cutting guide surface includes running a rotary cutting blade along the cutting guide surface.

7. The method of claim 1 wherein the step of removing a salvage material includes leaving a seam allowance of a predetermined width on the piping material.

8. An apparatus for trimming a salvage of a piping material, the apparatus comprising:
a transparent body;
a cording channel;
a cutting guide surface; and
a cutting tool.

9. The apparatus of claim 8 wherein the transparent body is composed of a transparent acrylic, plastic or glass.

10. The apparatus of claim 9 wherein the transparent acrylic, plastic or glass is a three-dimensional rectangular body having a top surface, a long side surface and a bottom surface.

11. The apparatus of claim 10 wherein the cording channel is a rectangular cut-out, with an opening on the bottom surface of the transparent body.

12. The apparatus of claim 10 wherein the cutting guide surface is the long side surface.

13. The apparatus of claim 8 wherein the cording channel is parallel to the cutting guide surface.

14. The apparatus of claim 8 wherein the piping material includes a cording material encased in a fabric and the salvage.

15. The apparatus of claim 14 wherein the fabric is a cloth, leather, vinyl, or flexible plastic.

16. The apparatus of claim 14 wherein the fabric contains a seam allowance portion.

17. The apparatus of claim 14 wherein the cording material is a flexible rope, plastic tubing, metal tubing or paper tubing having a diameter measuring less than the width of the cording channel.

18. The apparatus of claim 17 wherein the cording material encased in a fabric is positioned in the cording channel.

19. The apparatus of claim 8 wherein the trimming tool is a rotary cutting blade.

20. The apparatus of claim 19 wherein the rotary cutting blade cuts the salvage.
